(19) United States
(12) Patent Application Publication
(10) Pub. No.: US 2004/0169901 A1
(43) Pub. Date: Sep. 2, 2004

(54) Method and apparatus for scanning image

(75) Inventor: Hae-chul Kim, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 10/733,804

(22) Filed: Dec. 12, 2003

(30) Foreign Application Priority Data
Dec. 13, 2002 (KR) 2002-79432

(51) Int. Cl. H04N 1/04; H04N 1/46

(52) U.S. Cl. 358/509; 358/474

(57) ABSTRACT

A method and apparatus for scanning an image. The method includes determining whether the brightness of light sensed in the image input sensor is within a predetermined brightness range, if it is determined that the brightness of light is not within the predetermined brightness range, then the cover of the image forming apparatus is open and then closed, and image scanning is performed. However, if it is determined that the brightness of light is within the predetermined brightness range, the cover of the image forming apparatus is closed, and the image forming apparatus remains in an initialization state.

### CROSS-REFERENCE TO RELATED APPLICATIONS

This application claims the priority of Korean Patent Application No. 2002-79432, filed on Dec. 13, 2002, in the Korean Intellectual Property Office, the disclosure of which is incorporated herein by reference.

### BACKGROUND OF THE INVENTION

1. Field of the Invention

The present invention relates to image scanning in an image forming apparatus having an image input sensor for sensing an input image, a cover, and a lamp, and more particularly, to a method and apparatus for scanning an image, wherein it is determined whether the cover of the apparatus is open or closed using an image input sensor.

2. Description of the Related Art

An image forming apparatus such as a scanner or a multifunctional apparatus having a scanning function, comprises a cover, an image input sensor, an image processing unit, and a controlling unit.

The cover has a white bar or a white sheet on its bottom surface, to reflect light emitted from the image input sensor.

The image input sensor comprises a sensor for sensing reflected light, a fluorescent lamp used as a light source, a mirror, and a lens. Thus, the image input sensor emits light toward the cover and senses light reflected therefrom.

The image processing unit has an analog/digital converter to convert an analog image signal received from the image input sensor into a digital image signal. The image processing also has an image processor to perform shading of data, gamma correction, and image reduction/enlargement adjustment.

The controlling unit controls the entire image forming apparatus via a program for driving the entire system which is embedded in the controlling unit. Therefore, the controlling unit controls the image processing unit for scanning image data.

However, a conventional image forming apparatus comprises a sensor for sensing the opening of the cover to place a document in the image forming apparatus. When the sensor senses whether the cover is open or closed, the image forming apparatus performs image scanning in accordance with a predetermined scanning order. Thus, the conventional image forming apparatus requires additional elements such as an opening/closing sensor for sensing whether the cover is open or closed, a lever mechanism for performing an opening/closing operation, and a cable for connecting the opening/closing sensor which will result in an increase of the number of components and manufacturing costs increase.

### SUMMARY OF THE INVENTION

Accordingly, it is an aspect of the present invention to provide a method for scanning an image by which an image input sensor senses the brightness of light and it is determined whether a cover is open or closed without requiring an opening/closing sensor.

The foregoing and/or other aspects of the present invention are achieved by providing an apparatus for scanning an image in which the above-mentioned method for scanning an image is implemented.

Additional aspects and/or advantages of the invention will be set forth in part in the description which follows and, in part, will be obvious from the description, or may be learned by practice of the invention.

It is an aspect of the present invention to provide a method for scanning an image in an image forming apparatus having an image input sensor for sensing an input image and a cover, the method comprising determining whether a brightness of light sensed by the image input sensor is within a predetermined brightness range and outputting a result thereof; and determining whether to enable scanning the input image based upon the result.

Therefore, when it is determined that the brightness of light sensed by the image input sensor is not within the predetermined brightness range, the cover of the image forming apparatus has been opened and then closed, and image scanning may be performed. However, when it is determined that the brightness of light sensed by the image input sensor is within the predetermined brightness range, the cover of the image forming apparatus is closed, and the image forming apparatus remains in an initialization state.

It is another aspect of the present invention to provide an apparatus for scanning an image in an image forming apparatus having an image input sensor sensing an input image and a cover, the apparatus comprising a brightness check controlling unit which determines whether a brightness of light sensed in the image input sensor is within a predetermined brightness range and outputs a result in the form of a control signal; and an image scanning unit which selectively scans an image based upon the control signal.

### BRIEF DESCRIPTION OF THE DRAWINGS

These and/or other aspects and advantages of the invention will become apparent and more readily appreciated from the following description of the preferred embodiments taken in conjunction with the accompanying drawings of which:

FIG. 1 is a flowchart illustrating a method for scanning an image according to an embodiment of the present invention;

FIG. 2 is a flowchart illustrating step 10 shown in FIG. 1, according to the present invention;

FIG. 3 is a block diagram illustrating an apparatus for scanning an image according to an embodiment of the present invention; and

FIG. 4 is a block diagram illustrating a brightness check controlling unit shown in FIG. 3, according to the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

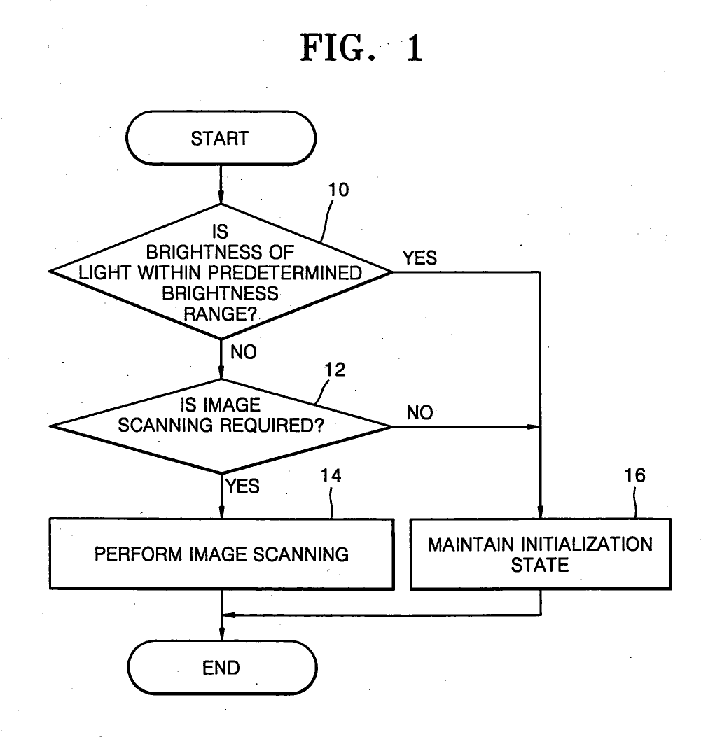

FIG. 1 is a flowchart illustrating a method for scanning an image according to the present invention. The method comprises operations 10-16 for determining whether a brightness of light is within a predetermined range, and scanning an image based upon the result.

First, in operation 10, it is determined whether the brightness of light sensed by an image input sensor is within a predetermined brightness range. If light emitted from a fluorescent lamp is reflected from a cover, the image input sensor senses the reflected light. When the cover is closed, the image input sensor senses a “white” brightness through light reflected from a white sheet provided on the bottom surface of the cover. However, when the cover is open, light is not reflected from the white sheet, and the image input sensor senses gray or black light. The predetermined brightness range is the range of brightness that can be determined as a “white” brightness in the image input sensor.

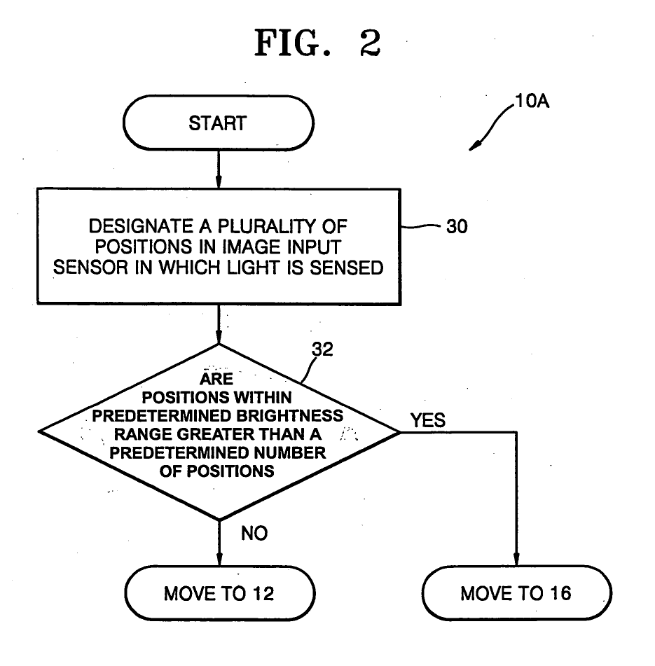

FIG. 2 is a flowchart illustrating operation 10A of operation 10 shown in FIG. 1, according to the present invention. Operation 10A comprises operations 30 and 32 for designating a plurality of positions in an image input sensor and determining whether the number of positions wherein the brightness of light is within a predetermined brightness range is greater than a predetermined number of positions.

In operation 30, a plurality of positions are designated in the image input sensor in which light is sensed. The image input sensor is rod-shaped and comprises a plurality of sensors for sensing light. The plurality of positions are designated based upon the plurality of sensors at predetermined intervals. Then the brightness of light is sensed at each position in the image input sensor.

Next in operation 32, it is determined whether the brightness of light sensed in the designated plurality of positions is within the predetermined brightness range, and it is determined whether a number of the plurality of positions of the image input sensor wherein the brightness of light is within the predetermined brightness range is greater than a predetermined number of positions. If it is determined that the number of the plurality of positions of the image input sensor wherein the brightness is within the predetermined brightness range is greater than the predetermined number of positions, then the brightness is within the predetermined brightness range. Next, it is determined whether the light sensed in the plurality of positions of the image input sensor is within a predetermined brightness range which corresponds to a “white” brightness range. When the number of the plurality of positions wherein the brightness of light is within the predetermined brightness range is greater than a predetermined number of positions, operation 10A proceeds to operation 16. When the number of the plurality of positions in which the brightness of light is within the predetermined brightness range is less than the predetermined number of positions, then operation 10A proceeds to operation 12.

For example, if 10 positions are designated in the image input sensor at predetermined intervals, it is determined whether the brightness of light at those 10 positions is within a predetermined brightness range which corresponds to a “white” brightness range. If it is determined that there are more than 7 positions within the predetermined brightness range then the brightness of light sensed by the image input sensor is within the predetermined brightness range, and operation 10A proceeds to operation 16. However, when it is determined that there are less than 7 positions within the predetermined brightness range among the 10 positions, then operation 10A proceeds to operation 12.

In operation 12, it is determined whether image scanning is required. If it is determined that image scanning is not required, then operation 12 proceeds to operation 16.

However, if it is determined that image scanning is required, operation 12 proceeds to operation 14, where image scanning is performed. By opening the cover and placing an input image in the image forming apparatus, and closing the cover, an image is scanned. Thus, if it is determined that the brightness of light sensed in the image input sensor is not within the predetermined brightness range, i.e., the “white” brightness range, and is within a gray or black brightness range, then it is determined that the cover is open and the input image is placed in the image forming apparatus and image scanning is performed.

If it is determined in operation 10 that the brightness of light sensed in the image input sensor is within the predetermined brightness range, then the cover is closed and operation 10 proceeds to operation 16 and the image forming apparatus remains in an initialization state. Thus, image scanning is not performed. Accordingly, if it is determined that the brightness of light sensed in the image input sensor is within the predetermined brightness range which corresponds to the “white” brightness range due to the reflection of the white sheet, it is determined that the cover of the image forming apparatus is maintained in a closed state, and an initialization state which is a state prior to image scanning, is maintained.

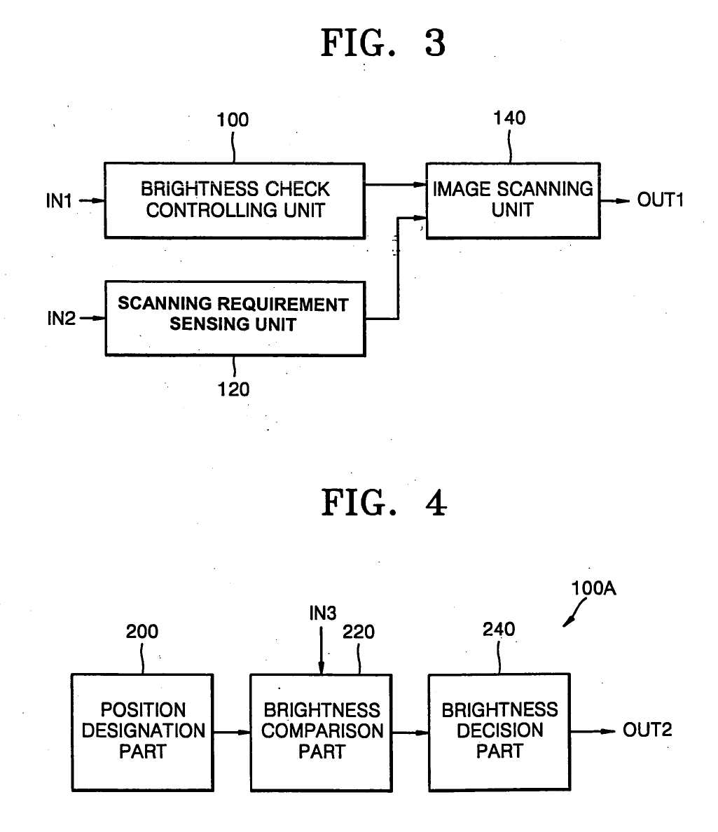

FIG. 3 is a block diagram illustrating an apparatus for scanning an image according to an embodiment of the present invention. Referring to FIG. 3, the apparatus comprises a brightness check controlling unit 100, a scanning requirement sensing unit 120, and an image scanning unit 140.

In order to perform operation 10, the brightness check controlling unit 100 determines whether the brightness of light sensed in an image input sensor is within a predetermined brightness range, and outputs the result in the form of a control signal. The brightness check controlling unit 100 receives the brightness of light sensed in the image input sensor through an input terminal IN1. The brightness check controlling unit 100 determines whether the brightness of light received is within the predetermined brightness range and outputs-the result to the image scanning unit 140.

FIG. 4 is a block diagram illustrating a brightness check controlling unit 100 shown in FIG. 3 . Referring to FIG. 4, the brightness check controlling unit 100 comprises a position designation part 200, a brightness comparison part 220, and a brightness decision part 240.

In order to perform operation 30 of FIG. 2, the position designation part 200 designates a plurality of positions in an image input sensor in which light is sensed, and outputs the result . The position designation part 200 designates the positions while maintaining the same distance at predetermined intervals. The position designation part 200 outputs the result to the brightness comparison part 220.

In order to perform operation 32, the brightness comparison part 220 determines whether the brightness of light sensed in the plurality of positions is within the predetermined brightness range, and outputs the result. The brightness comparison part 220 receives the brightness of light sensed in the image input sensor through an input terminal IN3, extracts the brightness of light sensed in the plurality of positions of the image input sensor received from the position designation part 200, and determines whether the brightness of light extracted is within the predetermined brightness range, i.e., a “white” brightness range. The brightness comparison part 220 outputs the result to the brightness decision part 240.

Also, in order to perform operation 32, the brightness decision part 240 determines whether a number of the plurality of positions in the image input sensor wherein the brightness of light is within the predetermined brightness range is greater than a predetermined number of positions, in response to the result from the brightness comparison part 220. For example, the brightness decision part 240 determines whether the number of the plurality of positions wherein the brightness of light is within the predetermined brightness range among the designated 10 positions of the image input sensor is greater than a predetermined number of positions, e.g., 7 positions. If it is determined that there are more than 7 positions having the brightness of light within the predetermined brightness range, the brightness decision part 240 determines that the brightness of light is within the predetermined brightness range. If it is determined that there are less than 7 positions within the predetermined brightness range, the brightness decision part 240 determines that the brightness of light is not within the predetermined brightness range. The brightness decision part 240 outputs the result in the form of a control signal to an output terminal OUT2.

In order to perform operation 12 of FIG. 1, the scanning requirement sensing unit 120 senses whether image scanning is required by a user, and outputs the result. The scanning requirement sensing unit 120 receives an image scanning requirement signal from the user through an input terminal IN2, senses whether image scanning is required, and outputs the result of sensing to the image scanning unit 140.

In order to perform operation 14 in FIG. 1, the image scanning unit 140 receives a control signal and scans an image. The image scanning unit 140 receives the control signal from the brightness check controlling unit 100. When a control signal indicates that the brightness of the light is within a predetermined brightness range, the image scanning unit 140 does not perform image scanning, and when a control signal in which the brightness of the light is not within the predetermined brightness range, the image scanning unit 140 performs image scanning in response to the result from the scanning requirement sensing unit 120. The image scanning unit 140 outputs a signal which instructs image scanning, to an output terminal OUT1, thereby performing image scanning.

As described above, in the method and apparatus for scanning an image according to the present invention, it can be determined whether a cover is open or closed using an image input sensor even though an opening/closing sensor for sensing whether a cover is open, and a lever mechanism for performing an opening/closing operation are not provided in a scanner or a multifunctional apparatus.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method for scanning an image in an image forming apparatus having an image input sensor for sensing an input image and a cover, the method comprising:
determining whether a brightness of light sensed by the image input sensor is within a predetermined brightness range and outputting a result thereof; and determining whether to enable scanning the image in the image forming apparatus based upon the result.

2. The method of claim 1, wherein the determining whether the brightness of light sensed by the image input sensor is within the predetermined brightness range, further comprises:
designating a plurality of positions based upon a plurality of sensors at predetermined intervals;
sensing the brightness of light at each position; and
determining whether a number of the plurality of positions wherein the brightness of light is within a predetermined brightness range is greater than a predetermined number of positions.

3. The method of claim 2, wherein the determining whether the number of the plurality of positions wherein the brightness of light is within the predetermined brightness range is greater than the predetermined number of positions, further comprises:
determining whether image scanning is required when the number of the plurality of positions wherein the brightness of light is within the predetermined brightness range is not greater than a predetermined number of positions and scanning the input image in an image scanning unit; and
the image forming apparatus remaining in an initialization state when the number of the plurality of positions wherein the brightness of light within the predetermined brightness range is greater than the predetermined number of positions.

4. An apparatus for scanning an image in an image forming apparatus having an image input sensor sensing an input image and a cover, the apparatus comprising:
a brightness check controlling unit which determines whether a brightness of light sensed in the image input sensor is within a predetermined brightness range and outputs a result in the form of a control signal; and
an image scanning unit which selectively scans an image based upon the control signal.

5. The apparatus of claim 4, wherein the brightness check controlling unit comprises:
a position designation part which designates a plurality of positions in the image input sensor in which light is sensed, and outputs a result;
a brightness comparison part which determines whether the brightness of light sensed in the plurality of positions is within the predetermined brightness range, and outputs a result; and
a brightness decision part which determines whether a number of the plurality of positions in the image input sensor wherein the brightness of light is within the predetermined brightness range is greater than a predetermined number of positions, in response to the result from the brightness comparison part.

6. The apparatus of claim 4, further comprising a scanning requirement sensing unit which senses whether image scanning is required by a user, and outputs a result to the image scanning unit.

7. The method of claim 1, wherein when the cover is closed, the image input sensor senses a “white” brightness through a light reflected from a white sheet provided on a bottom surface of the cover.

8. The method of claim 1, wherein when the cover is open, a light is not reflected from a white sheet provided on a bottom surface of the cover, and the image input sensor senses a gray, black or other nonwhite color light.

9. The apparatus of claim 4, wherein the brightness check controlling unit receives the brightness of light sensed in the image input sensor through an input terminal;
determines whether the brightness of light received is within the predetermined brightness range; and
outputs the result to the image scanning unit.

10. The apparatus of claim 5, wherein the position designation part designates the positions while maintaining the same distance at predetermined intervals.

11. The apparatus of claim 5, wherein the brightness comparison part receives the brightness of light sensed in the image input sensor through an input terminal;
extracts the brightness of light sensed in the plurality of positions of the image input sensor received from the position designation part;
determines whether the brightness of light extracted is within the predetermined brightness range; and
outputs the result to the brightness decision part.
